(19) United States
(12) Patent Application Publication
(10) Pub. No.: US 2014/0040750 A1
(43) Pub. Date: Feb. 6, 2014

(54) ENTITY MANAGEMENT DASHBOARD

(71) Applicants: Kamath Harish B., Bengalooru Karanataka (IN); Kasthurirengan Karthigeyan, Bangalore Karnataka (IN); Maninder Singh Raniyal, Bangalore Karnataka (IN)

(72) Inventors: Kamath Harish B., Bengalooru Karanataka (IN); Kasthurirengan Karthigeyan, Bangalore Karnataka (IN); Maninder Singh Raniyal, Bangalore Karnataka (IN)

(21) Appl. No.: 13/563,018

(22) Filed: Jul. 31, 2012

(51) Int. Cl. G06F 15/177

(52) U.S. Cl. 715/735; 715/736

(57) ABSTRACT

An entity management dashboard is implemented according to systems and methods disclosed herein. An example method may include displaying a first entity of a computer network in an entity management dashboard. The example method may also include linking the first entity to a second entity of the computer network when the first entity is graphically connected to the second entity to deliver content against a context.

### BACKGROUND

Information technology (IT) professionals are often called on to identify and configure resources (e.g., devices, applications, and user permissions) in computing environments. This often means that the IT professional opens a dialog box and searches through menus (even nested menus) to find the appropriate configuration panel so that he or she can manually enter the desired settings. This approach is time-intensive, demands expertise, and relies on a working knowledge of the specific computing environment being addressed. Multi-vendor and “cloud” computing, environments can make this task even more complex. In addition, computing environments change over time when devices are replaced, reconfigured, updated, moved, and/or new resources are introduced. These and other factors can make the job of IT professionals even more difficult.

### BRIEF DESCRIPTION OF THE DRAWINGS

FIG. 1 is a high-level illustration of an example system which may implement an entity management dashboard in a computing environment.

FIG. 2 is a process-flow diagram illustrating example implementation of an entity management dashboard by an architecture of machine readable instructions.

FIGS. 3a-e are screen shots illustrating input/output operations in an example entity management dashboard.

FIG. 4 is a flowchart illustrating example operations which may implement an entity management dashboard.

### DETAILED DESCRIPTION

Configuring a computing environment can be a time-consuming task. Even relatively smaller computing environments can include many devices, operating systems, and applications, along with user properties and permissions. While the IT professional may employ resource configuration software, the IT professional may be restricted to a predetermined context of functions (e.g., typically provided as a list in a drop down menu).

The systems and methods described herein enable an IT professional to build relationships among a variety of entities in a computing environment, link entities to other entities, and execute various functions, for example, to automatically configure devices, operating systems, user properties, and applications in a computing environment. As an example of automatic configuration of devices, consider associating a role (e.g., Network Operator) to a user who has access to multiple hosts. When the role assignment function is executed, the role is first provisioned on to the systems and then applied to the user. For example, User1 has access to nodes Palo Alto, Florida and Boston. If User1 is a network administrator of the Palo Alto system through a relationship mechanism, it may be desirable for User1 to also be a network administrator for Florida and/or Boston as well. Accordingly, the systems and methods described herein propagates the Network Administrator records onto these system(s), and then associates these records with User1.

In an example, the systems and methods may be implemented as an intuitive graphical interface as part of a software tool. The graphical interface enables the IT professional to understand entities and the relationships of various entities to other entities and to users, divulge information against relationships, and execute functions in any given context (even across platforms). The graphical interface enables the IT professional to build relationships via line connect, object move, and/or drag-and-drop operations.

The systems and methods facilitate intuitive logical connections and configuration of entities and realize a set of functions applicable against any given context. The intuitive graphical interface enables the user to comprehend system configuration with ease. The views and functions also enable users to detect vulnerabilities, for example, when managing security entities.

Before continuing, it is noted that as used herein, the terms “includes” and “including” mean, but is not limited to, “includes” or “including” and “includes at least” or “including at least.” The term “based on” means “based on” and “based at least in part on.”

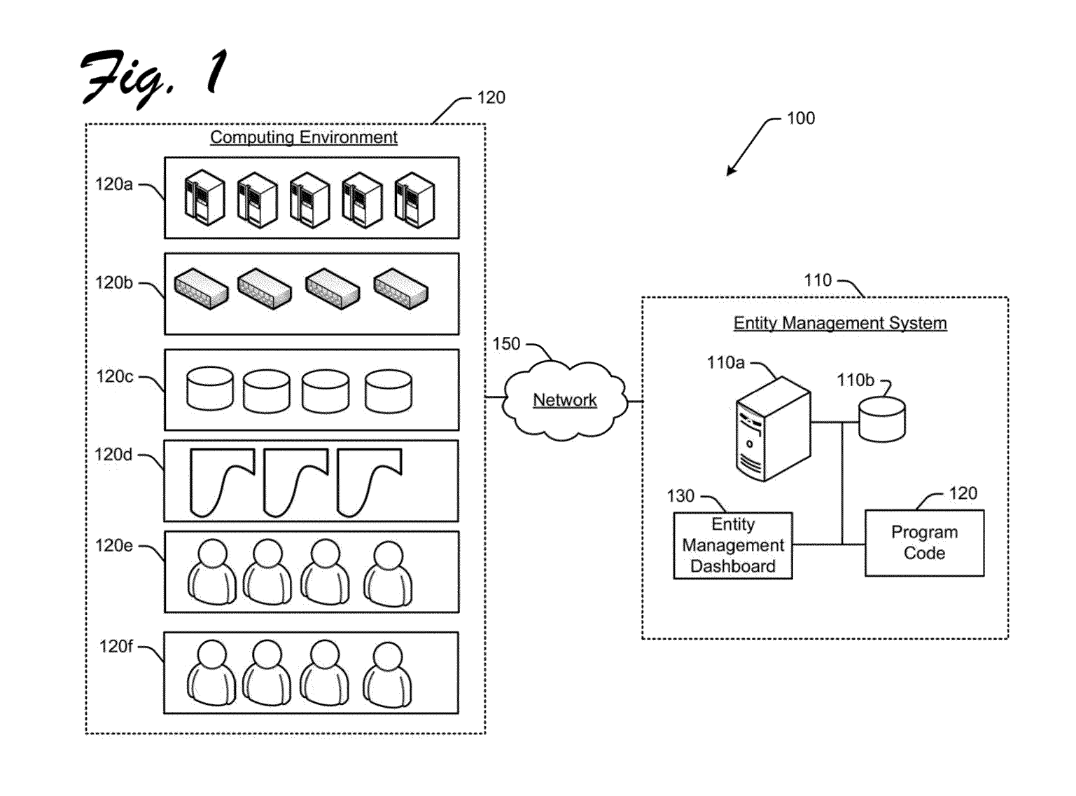

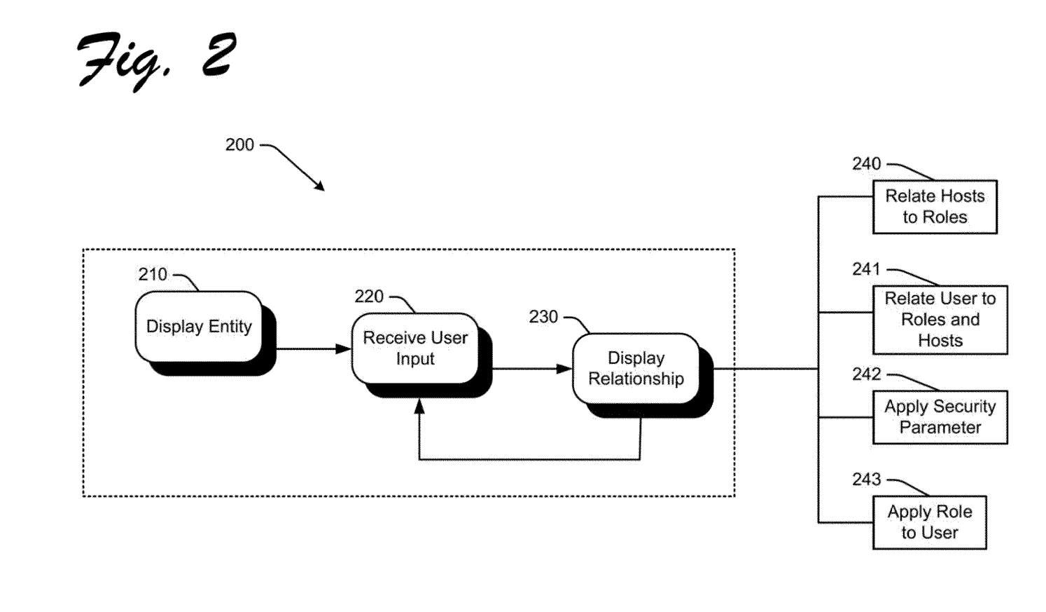

FIG. 1 is a high-level illustration of an example system 100 which may implement an entity management dashboard in a computing environment 120.

The system 100 may include an entity management system 110 including a processor 110a operatively associated with computer readable media 110b, and configured to execute program code 120 to enable interaction with a user via a graphical interface referred to herein as the entity management dashboard 130.

The entity management system 110 may be configured to identify network entities in the computing environment 120. The entity management system 110 may store the identity of entities and corresponding configurations in a local repository (e.g., in the computer readable media 110b). The entity management system 110 serves as an intermediary between operator of the entity management dashboard 130 and components of the computing environment 120.

In an example, the computing environment 120 is implemented as a multi-vendor management environment or cloud computing environment, such as an enterprise computing system(s) or multi-user data center(s). These computing systems offer a consolidated environment for providing, maintaining, and upgrading hardware and software for the users, in addition to more convenient remote access and collaboration by many users. These computing systems also provide more efficient delivery of computing services. For example, it is common for the processor and data storage for a typical desktop computer to sit idle over 90% of the time during use. This is because the most commonly used applications (e.g., word processing, spreadsheets, and Internet browsers) do not require many entities. By consolidating processing and data storage in a computing environment such as a data center, the same processor can be used to provide services to multiple users at the same time.

The computing environment 120 is shown in FIG. 1 including hardware systems/subsystems of servers 120a, network devices 120b, and storage devices 120c. Applications 120d are also illustrated as these may be executed by device hardware. It is noted that the hardware systems/subsystems 120a-c may also include dedicated software platforms (e.g., operating systems and firmware) for operating the devices. Administrators 120e and users 120f are also illustrated as they may interact with the physical and software layers provided in the computing environment.

It is noted that computing environment 120 is shown for purposes of illustration and the components shown are not intended to be limiting. The computing environment 120 may include any number and type of devices, systems, subsystems, and/or executing code (e.g., software applications), just to name a few examples of equipment and infrastructure. The number and type of entities provided in computing environment 120 may depend at least to some extent on the type of customer, number of customers being served, and the customer requirements. The computing environment 120 may be any size. For example, the computing environment 120 may serve an enterprise, the users of multiple organizations, multiple individual entities, or a combination thereof.

Regardless of the physical configuration of the computing environment 120, communications are typically network-based. The most common communications protocol is the Internet protocol (IP), however, other network communications may also be used. Network communications may be used to make connections with internal and/or external networks. Accordingly, the computing environment 120 may be connected by routers and switches and/or other network equipment that move network traffic between the servers and/or other computing equipment, data storage equipment, and/or other electronic devices and equipment in the computing environment 120 (referred to herein generally as “computing infrastructure”).

In an example, entity management system 110 may be connected to the computing environment 120 via a network, such as an external network 150 either directly indirectly. In another example, the entity management system 110 may be included as part of or embedded within the computing environment 120 (e.g., connected via an internal network).

It is noted that the entity management techniques described herein are not limited to use with any particular type, number or configuration of facilities infrastructure. The computing environment 120 shown in FIG. 1 is provided as an illustration of an example operational environment, but is not intended to be limiting in any manner.

A purpose of the computing environment 120 is providing facility and computing infrastructure for end-users (or “users”) with access to computing entities, including but not limited to data processing entities, data storage, and/or application handling. A user may include anybody (or any entity) who desires access to entity(s) in the computing environment 120. The users may also include anybody who desires access to a service provided via the computing environment 120. Providing the users access to the entities may also include provisioning of the entities, e.g., via file servers, application servers, and the associated middleware. This also means that the IT personnel (or “operator”) have to provide dependable and reliable service to the computing environment.

An operator, as the term is used herein, may include anybody (or any entity), or plurality thereof, responsible for managing the computing environment 120. For purposes of illustration, an operator may be IT personnel or administrator(s) in charge of managing communication elements to provide consistent networking on behalf of the users. In another example, the operator may be an engineer in charge of deploying and managing processing and data storage entities for the users. The function of the operator may be partially or fully automated.

The operator may use information about the computing environment 120 (including hardware, software, networks, and the users) to provision computing services. Provisioning computing services may include initial setup, and adding/removing/updating equipment and/or users over time, and the related configuration. The operator may also be responsible for managing events such as network outages and upgrades. The entity management system 110 provides the operator with an intuitive graphical interface to aid in provisioning and managing computing services in the computing environment 130.

The function of the entity management system 110 may be implemented by program code 120, which may be stored on any suitable computer readable media and executed by any suitable computing device (e.g., provided by the entity management system 110). During execution of the program code 120, the entity management system 110 identifies and learns about different types of entities published in a system, and presents a graphical appearance of these entities to the operator. The term “entity” is used herein to describe any device, user, or object defined in the computing environment 120, along with corresponding configuration parameters and/or other information.

As an example, an entity may be a physical device or system in the computing environment, such as storage devices (e.g., network storage), processing devices (e.g., server computers), user devices (e.g., desktop or laptop computers), and communication devices (e.g., network routers and switches). These types of entities may be referred to as “physical entities” because these entities have a physical presence in the computing environment.

An entity may also be a “virtual entity.” For example, an entity may be a host, a user, and/or a role. Virtual entities do not have a physical presence in the computing environment. Other examples of virtual entities include, but are not limited to, network domains and partitions (e.g., on storage devices or processing resources). While these may be instantiated on physical devices (e.g., network and storage devices), these entities do not have a physical existence separate from the underlying devices, and may be defined and redefined across multiple different physical devices in the computing environment. As such, these are also considered to be virtual entities.

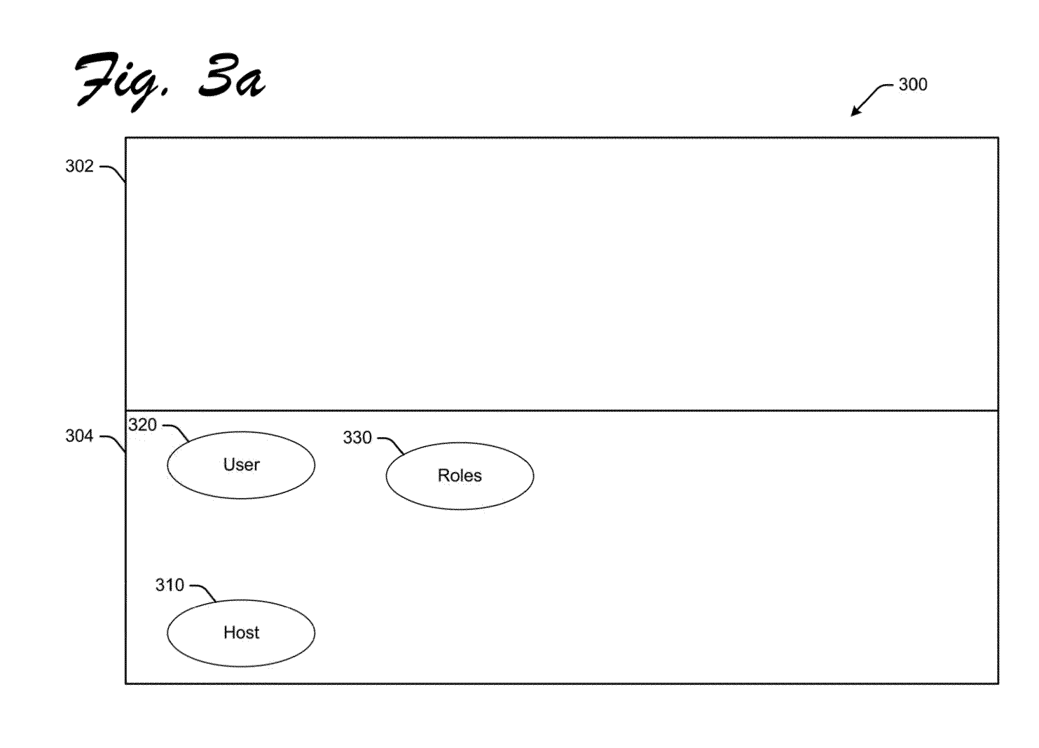

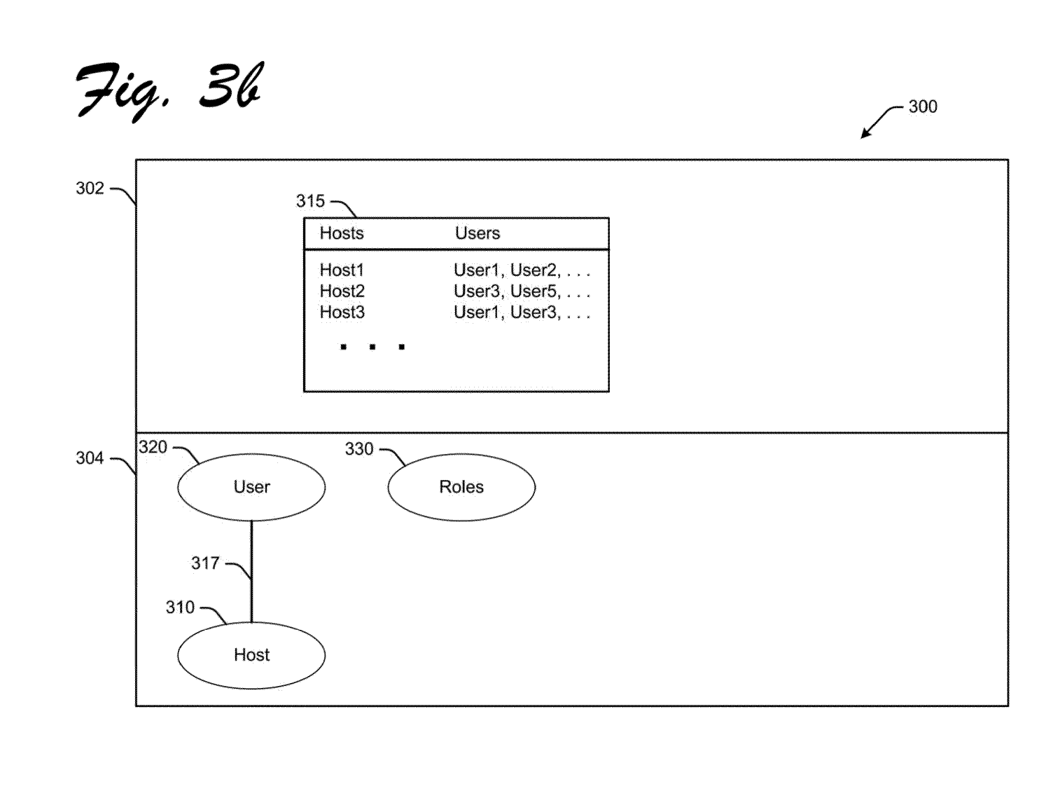

During use, the operator can connect the entities presented in the entity management dashboard 130, for example, by using directional lines in the graphical interface to establish a relationship between the entities. The result of the relationship between entities may also be presented to the operator. Various functions may also be executed using entity management dashboard 130. Examples are described in more detail below with reference to FIG. 2.

FIG. 2 is a process-flow diagram 200 illustrating example implementation of an entity management dashboard by an architecture of machine readable instructions. In an example, the program code 120 discussed above with reference to FIG. 1 may be implemented in machine-readable instructions (such as but not limited to, software or firmware). The machine-readable instructions may be stored on a non-transient computer readable medium and are executable by one or more processor to perform the operations described herein. It is noted, however, that FIG. 2 is provided only for purposes of illustration of an example operating environment, and is not intended to be limiting.

The program code may execute the function of the architecture of machine readable instructions as self-contained modules. These modules can be integrated within a self-standing tool, or may be implemented as agents that run on top of existing program code. In an example, the modules may execute to display 210 an entity (or entities) in the entity management dashboard, receive 220 user input, and then output or display 230 a relationship between one or more entity.

The entity management system described above with reference to FIG. 1 can be implemented to learn different types of entities published in a system, and present a graphical appearance of these entities to the operator. The presented set of entities can be connected by the operator using directional lines in the graphical interface to establish a relationship between the entities. The result of relationship may be presented to the user as a list. Accordingly, the program code simplifies relationship building among a set of entities in the computing environment, and may be utilized to deliver content against a context.

Delivering content against context may include establishing a context against a first entity of computer network (or computing environment) to reveal content of a second entity of the computer network, establishing relationships between the first and second entity, and applying parameters of the second entity to the first entity. As an illustration, consider an example where an operator may establish a context against User 1, revealing content such as a list of roles being performed, list of hosts that User1 has access to, and type of roles that User1 is allowed to perform on these hosts. As another example, the user may establish relationships between entities to deliver information about various hosts in an enterprise, number of users having access to those systems, and types of roles on such systems. In another example, the user may drag and drop security parameters onto a file, resulting in the selected security parameters being applied based on the file type, validity or resource ownership permissions.

In an example, the entity management dashboard may be used to relate Hosts to Roles. That is, the operator may graphically connect “Hosts” and “Roles” icons with a line. In response, the entity management system may execute the following pseudocode 240:

| | |
|---|---|
| 1. | Relate(Hosts, Roles); |
| 2. | Create a table, with tablename “Hosts”; |
| 3. | Display item list in the created table, for each host display |
| | corresponding roles. |

This results in the entity management dashboard displaying 230 a table or list of roles available on each of the hosts.

As another illustration, the entity management dashboard may be used to relate a User to Roles and Hosts. The operator connects the “Users” graphical object to the “Roles” graphical object with a line. In response, the entity management system may execute the following pseudocode 241:

| | |
|---|---|
| 1. | Execute Relate(Users, Roles); |
| 2. | Create a table, with tablename “Users”; |
| 3. | Display item list in the created table, for each user display |
| | corresponding roles; |
| 4. | Connect “Users” to “Hosts” graphical objects with a line; |
| 5. | Execute Relate(Users, Hosts); |
| 6. | Display item list in the created table, for each user display |
| | corresponding Hosts. |

This results in the entity management dashboard displaying 230 a table with each row bearing user names, and having two columns. One column lists roles associated with a user and the other column represents hosts to which user has access.

In addition, the entity management dashboard may be used to operate (or execute functions) on the entities. That is, the entities may be assets of one or more products that can be used to perform one or more functions.

For purposes of illustration, the entity management system may execute the following pseudocode 242 to apply a security parameter:

| | |
|---|---|
| 1. | Connect “Users”to “Encrypted Files” graphical objects with a |
| | line |
| 2. | Execute Relate(Users, Encrypte Files) |
| 3. | Create a table, with tablename “Users” |
| 4. | Display item list in the created table, for eachuser display |
| | corresponding encrypted files |
| 5. | Connect “Users”to “Keypairs” graphical objects with a line |
| 6. | Execute Relate(Users, Keypairs) |
| 7. | Display item list in the created table, for eachuser display |
| | corresponding keypairs |
| 8. | Connect “Encrypted Files” to “Keypairs” (This may be an |
| | internal operation and not performed by the user) |
| 9. | Update the table with relationship between “Encrypted Files” and |
| | “Keypairs”, e.g., using icons |
| 10. | Drag and drop keypair on to associated encrypted file |
| 11. | Execute Decrypt(Encrypted File, Keypair) |
| 12. | Generate a corresponding plain file. |

According to the pseudocode above, the entity management dashboard may be used to relate a User to Secured Files and also relate the User to a Security Attribute (e.g., a security level). The result of these directional connections results in a User table being displayed listing the secured Files and security levels against each user. The relationship operation may also result in presenting association of security levels with the corresponding file object and or may also reveal secured files without a security level object. The user may unsecure the file by dragging and dropping the security level value from a cell of a table onto secured file in the same table or another table.

As another illustration the entity management dashboard may be used to apply a Role to a User. The operator may connect the “Users” graphical object to the “Roles” graphical object with a line. In response, the entity management system may execute the following pseudocode 243:

| | |
|---|---|
| 1. | Execute Relate(Users, Roles) |
| 2. | Create a table, with tablename “Users” |
| 3. | Display item list in the created table, for each user display |
| | corresponding Roles |
| 4. | Connect “Users” to “Hosts” graphical objects with a line |
| 5. | Execute Relate(Users, Hosts) |
| 6. | Display item list in the created table, for each user display |
| | corresponding Hosts |
| 7. | Drag and drop a role on to associated user |
| 8. | Execute RoleProvision(User, ALL_HOSTS, role) |

This results in the entity management dashboard displaying 230 a table with each row bearing user names, and having columns for roles and hosts. User if drags role onto a user, role is applied to user on all hosts.

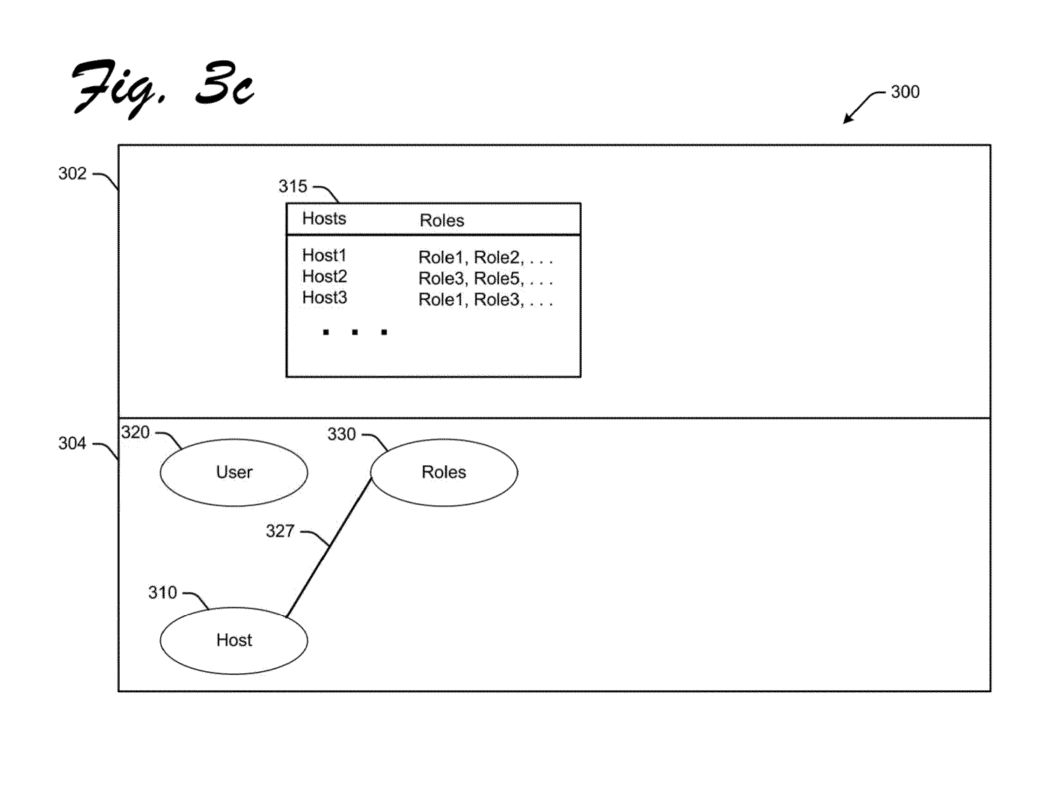

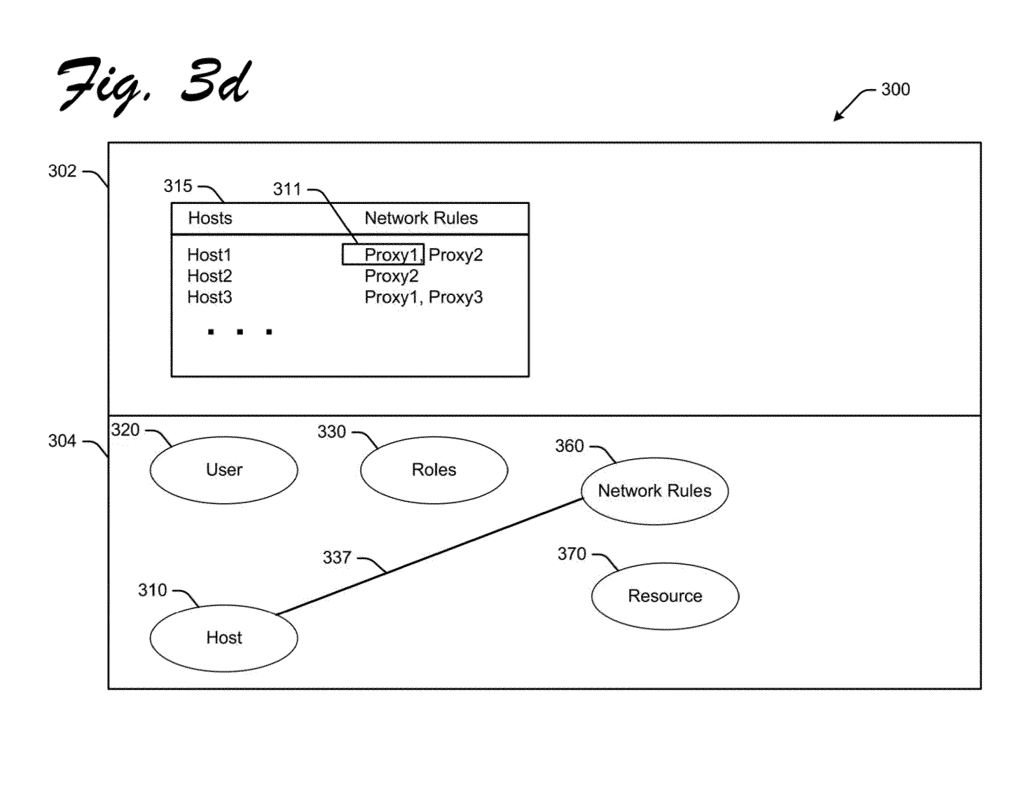

The above examples illustrate relationship building to deliver content against a context, and executing functions among a set of entities in the computing environment. Example operations are described below with reference to the illustrations shown in FIGS. 3a-d. However, the operations described herein are not limited to any specific implementation.

FIGS. 3a-d are screen shots illustrating input/output operations in an example entity management dashboard 300. In an example, the entity management dashboard 300 may include a window 302 for displaying tables or lists, and an icon window 304. The icon window 304 may display an entity or entities (e.g., one or more of the host icon 310, the user icon 320, and the roles icon 330). The entities may be local to a host or shared among hosts in an IT environment. The operator may link the first entity to a second entity in the entity management dashboard 300 by graphically connecting the entity (e.g., using a mouse or other pointer device) to another entity. In an example, the entity management dashboard may persist the graphical relationship for re-use (e.g., as shown between FIGS. 3a-d).

With reference to the illustration shown in FIGS. 3a to 3b, the operator may select the host icon 310 and draw a line 317 relating host icon 310 to the user icon 320. This action causes the entity management dashboard 300 to display a host table 315 in window 302. The host table 315 includes rows corresponding to Hosts in the computing environment (e.g., Host1, Host2, and Host3), and column(s), for example, identifying users on each of the hosts.

With reference to the illustration shown in FIGS. 3b to 3c, when the user further connects the host icon 310 to the roles icon 330, then the host table 315 is updated with another column, where each row corresponds to a host and a list of roles configured against each host.

It is noted that a User table may be created when making a connection from the user icon 320 to another entity (e.g., roles, hosts, and events). In an example, relations may be established as Hosts to Users (launching the host table 315), Users to Roles (the users table is launched), Roles to Users (a roles table is launched), Users to Hosts (the users table is launched), users to roles (the users table is updated), and so forth.

With reference to the illustration shown in FIG. 3d, network rules (such as proxy settings, and firewall settings) may be applied to a host as follows. A relation may be established as discussed above to display the Hosts table 315. Then, the operator may relate Host icon 310 to Network Rules icon 360 (as illustrated by the dashed line), and the Hosts table 315 is populated with host names and corresponding network rules in window 302. If Proxy 1 and Proxy 2 are found on Host1, while Host2 contains only Proxy2, the operator can drag and drop Proxy1 (by selecting box 311) appearing against Host1 onto Host2 of the Host Table 315. It is noted that the Drag and Drop operation is most commonly used with data displayed in window 302, but may also be used between windows 302 and 304. For example, the operator can expand the Network Rules icon 360 in window 304 to display a list of a universal set of network rules (e.g., Proxy1, Proxy2), against a hierarchy. The operator may then drag Proxy1 onto Host2.

The operator may further establish relationships, execute functions, and/or establish roles via drag/drop actions, as illustrated in FIG. 3d. By way of example, the operator may select a host (e.g., Host2) from the host table 315 and drag/drop (as illustrated by line 337) the selected host 311 onto a network rules icon 360 to associate network rules with the selected host 311. In another example, the operator may select a host from the host table 315 and drag/drop the selected host 311 onto a resource icon 370 to list resource types available to the host. This action may display a resource table (not shown) or another column in the host table (not shown) listing the resources associated with the selected host 311, such as printers, communication devices, storage devices, and applications, to name only a few examples. The operator may also associate a resource (e.g., a printer) with the selected host 311 with similar drag/drop operations.

The operator may further execute security operations via drag/drop actions, as illustrated in FIG. 3e. For example, the entity management dashboard 300 can be used to detect the hardened (security) level of a host. The operator connects the Host icon 310 to the security level 380, and the security level of the host is displayed in host table 315 along with the Host name. It can be seen in this illustration that each user has different security levels.

The operator may change the security level of a host by applying a security value on to the Host, for example via drag & drop operation similar to that described above with reference to FIG. 3d. A list of security operations may also be provided as part of this operation.

If the operator wants to apply a different security attribute to these hosts (e.g., to make all hosts have the same security level), the operator may use the entity management dashboard 300 to automatically configure an entity when the entity is graphically connected to a configuration icon in the entity management dashboard. By way of illustration, the operator may select one of the security levels by positioning the cursor over the desired security level (e.g., at box 312), and drag/drop the security level box 312 onto the desired host (e.g., Host2). This action links the selected host to the selected security attribute, and accordingly assigns all of the selected hosts the selected security attribute.

The operator may also use the entity management dashboard to apply functions from across different applications to resources in a computing environment. That is, the entity management dashboard may be integrated with different applications (e.g., security, network policy, printer configuration) so that the operator can apply functions available via each of these separate applications to multiple different resources in the computing environment, using only the entity management dashboard and without having to open each of the different applications to execute the different functions.

The systems and methods described herein have been described as a tool which may be used to at least partially automate entity management, thereby reducing the cost incurred for domain expertise to manually manage entities in a computing environment. The tool may also provide a graphical interface for simplicity and ease of use by the operator. The graphical interface provides an intuitive interface that enables the operator to relate and operate on resources in a computing environment, and is presented with contextual information and corresponding operations for the various resources.

The graphical interface described above is user-centric. That is, the operator does not need to have any prior knowledge of the computing environment, devices in the computing environment, or users of the computing environment, to perform various operations on the resources. In addition, the user is able to operate across different platforms, applying functions from different types of applications. The entity management dashboard enables the operator to seamlessly include/exclude products in the computing environment.

Before continuing, it should be noted that the examples described above are provided for purposes of illustration, and are not intended to be limiting. Other devices and/or device configurations may be utilized to carry out the operations described herein.

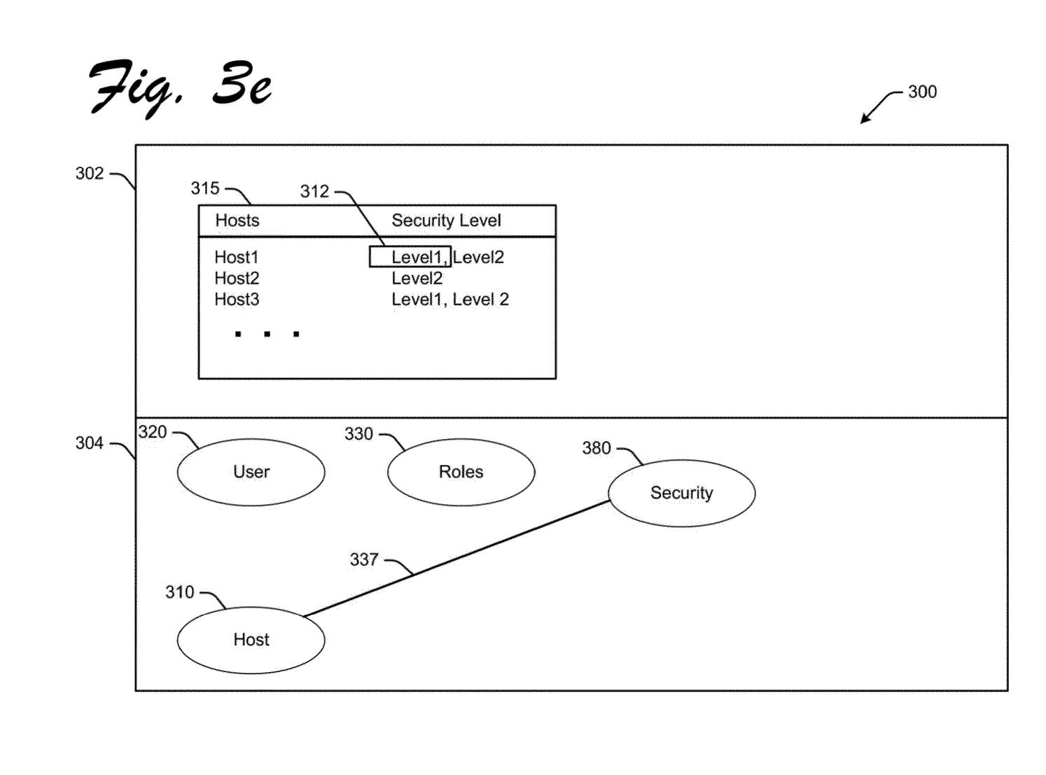

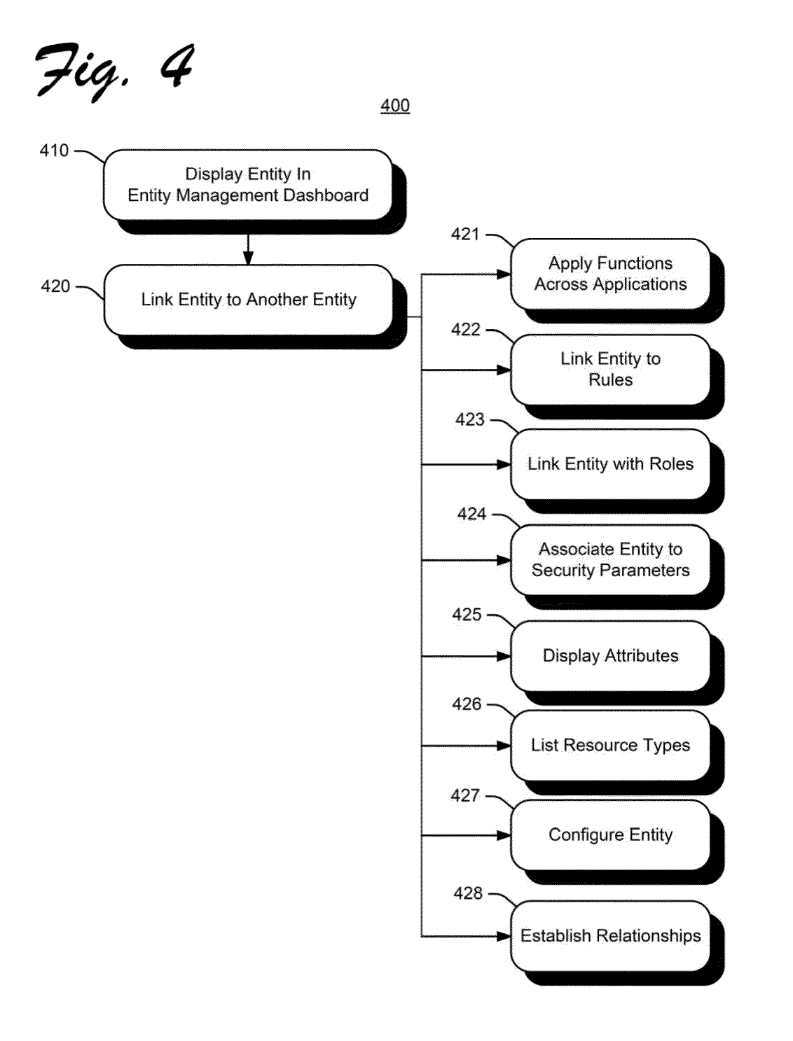

FIG. 4 is a flowchart illustrating example operations which may implement an entity management dashboard. Operations 400 may be embodied as logic instructions on one or more computer-readable medium. When executed on a processor, the logic instructions cause a general purpose computing device to be programmed as a special-purpose machine that implements the described operations. In an example, the components and connections depicted in the figures may be used.

Operation 410 includes displaying a first entity in an entity management dashboard. Operation 420 includes linking the first entity to a second entity when the first entity is graphically connected to the second entity to deliver content against a context.

The operations shown and described herein are provided to illustrate example implementations. It is noted that the operations are not limited to the ordering shown. Still other operations may also be implemented.

For example, operation 421 may include applying functions from across different applications to resources in a computing environment. Operation 422 may include linking the first entity to rules defined by the second entity. Operation 423 may include linking the first entity to user roles defined by the second entity. Operation 424 may include linking the first entity to the second entity associates the first entity with security attributes defined by the second entity. Operation 425 may include listing entity attributes of the first entity when the first entity is graphically connected to an entity attributes icon in the entity management dashboard. Operation 426 may include listing resource types available to the first entity when the first entity is graphically connected to a resource types icon in the entity management dashboard. Operation 427 may include automatically configuring the first entity when the first entity is graphically connected to a configuration icon in the entity management dashboard. Operation 428 may include establishing a relationship between the first entity and the second entity when the first entity is graphically connected to another entity in the entity management dashboard. It is noted that there may be any number and/or type of resources, and Roles and Security are only shown for purposes of illustration.

The operations may be implemented at least in part using an online browser (e.g., web-based interface). In an example, the end-user is able to make predetermined selections, and the operations described above are implemented on a back-end device to present results to a user. The user can then make further selections. It is also noted that various of the operations described herein may be automated or partially automated.

It is noted that the examples shown and described are provided for purposes of illustration and are not intended to be limiting. Still other examples are also contemplated.

1. A method, comprising:
displaying a first entity of a computer network in an entity management dashboard;
linking the first entity to a second entity of the computer network when the first entity is graphically connected to the second entity to deliver content against context.

2. The method of claim 1, wherein delivering content against context comprises establishing a context against the first entity to reveal content of the second entity, establishing relationships between the first and second entity, and applying parameters of the second entity to the first entity.

3. The method of claim 1, wherein linking the first entity to the second entity links the first entity to rules defined by the second entity.

4. The method of claim 1, wherein linking the first entity to the second entity links the first entity to user roles defined by the second entity.

5. The method of claim 1, wherein linking the first entity to the second entity associates the first entity with security attributes defined by the second entity.

6. The method of claim 1, further comprising displaying entity attributes of the first entity when the first entity is graphically connected to an entity attributes icon in the entity management dashboard.

7. The method of claim 1, further comprising listing resource types available to the first entity when the first entity is graphically connected to a resource types icon in the entity management dashboard.

8. The method of claim 1, further comprising automatically configuring the first entity when the first entity is graphically connected to a configuration icon in the entity management dashboard.

9. The method of claim 1, further comprising establishing a relationship between the first entity and the second entity when the first entity is graphically connected to another entity in the entity management dashboard.

10. An entity management dashboard comprising program code stored on a computer readable medium and executable by a processor to:
display a first entity of a computer network in a graphical interface;
link the first entity to a second entity of the computer network when the first entity is connected to the second entity in the graphical interface to deliver content against a context.

11. The entity management dashboard of claim 10, wherein the program code is further executable to apply functions from across different applications to resources in the computer network.

12. The entity management dashboard of claim 10, wherein the program code is further executable to link the first entity to rules defined by the second entity.

13. The entity management dashboard of claim 10, wherein the program code is further executable to link the first entity to user roles, volumes, files, hosts, and events, as defined by the second entity.

14. The entity management dashboard of claim 10, wherein the program code is further executable to associate the first entity with security attributes defined by the second entity.

15. The entity management dashboard of claim 10, wherein the program code is further executable to display entity attributes of the first entity when the first entity is graphically connected to an entity attributes icon.

16. The entity management dashboard of claim 10, wherein the program code is further executable to list resource types of the first entity when the first entity is graphically connected to a resource types icon.

17. The entity management dashboard of claim 10, wherein the program code is further executable to configure the first entity when the first entity is graphically connected to a configuration icon.

18. The entity management dashboard of claim 10, wherein the program code is further executable to link establish a relationship between the first entity and another entity.

19. A system comprising:
a graphical interface configured to display a first entity of a computer network in an entity management dashboard;
an entity manager to link the first entity to a second entity of the computer network when the first entity is connected to the second entity in the graphical interface to deliver content against a context.

20. The system of claim 19, wherein the entity manager generates output from different applications based on the link between the first entity and the second entity.
